(19) United States
(12) Patent Application Publication
(10) Pub. No.: US 2009/0144656 A1
(43) Pub. Date: Jun. 4, 2009

(54) METHOD AND SYSTEM FOR PROCESSING MULTILAYER DOCUMENT USING TOUCH SCREEN

(75) Inventors: Hyun-Jung KWON, Seoul (KR); Ju-Hyun KO, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 12/261,762

(22) Filed: Oct. 30, 2008

(30) Foreign Application Priority Data
Nov. 29, 2007 (KR) 10-2007-0122898

(51) Int. Cl. G06F 3/048; G06F 3/033

(52) U.S. Cl. 715/808; 715/863

(57) ABSTRACT

A method and system of processing a multilayer document using a touch screen is provided. The method of processing a multilayer document using a touch screen, including receiving a first input via the touch screen, creating a plurality of documents according to the first input, wherein the documents are divided by layers; receiving a second input via the touch screen, and performing a document command on the plurality of documents according to the second input by at least one of merging, segmenting, and deleting the layers.

### CROSS REFERENCE TO RELATED APPLICATION

This application claims priority from Korean Patent Application No. 10-2007-0122898 filed on Nov. 29, 2007 in the Korean Intellectual Property Office, the disclosure of which is incorporated herein by reference in its entirety.

### BACKGROUND OF THE INVENTION

1. Field of the Invention

Methods and systems consistent with the present invention relate to processing a multilayer document on a touch screen, and, in particular, to creating and editing a document on a touch screen.

2. Description of the Related Art

In recent years, there have been many attempts to display documents using an intuitive interface and minimum number of operations, instead of searching for data or editing documents using a complex interface.

One of the attempts is a touch screen input system, in which a user performs intuitive input with his/her finger on a display screen. A touch screen may be used, for example, in an MP3 player, a portable multimedia player (PMP), a personal digital assistant (PDA), or an ultra mobile personal computer (UMPC), in terms of a compact and light-weight interface, instead of an additional input device or an input button. The user may perform the intuitive input by touching the touch screen with his/her finger or a pen.

FIG. 1 shows an example of a menu structure of a general memo pad. When the user selects or clicks a desired function on a top menu, a general interface for creating a document executes the corresponding function. To create and save a document, to cut and copy, or move part of the document, the user needs to find a function on the menu using a tool, such as a mouse. Particularly, to reduce time required for finding a function on the menu, changing the position of the tool, and selecting the function, the user may use shortcut keys.

The above described menu structure has a problem in that the user needs to understand the overall structure of the menu. As the number of functions increases, the structure becomes complicated, and, accordingly, it takes a great deal of time for the user to find a desired function in the hierarchical menu structure. Particularly, since the menu structure is an interface that is suitable for a personal computer (PC), when it is mounted on a compact portable terminal, such as a PDA, it is difficult for the user to control the menu with his/her finger or the pen. In addition, the menu or button needs to have a substantial size for the user to recognize it, which results in decreasing the size of the usable region.

Therefore, there is a need for a method and system that, in creating a document or a memo on the touch screen, can intuitively edit the document or the memo, without using the menu structure.

In addition to editing, the user may wish to create a memo or save a document through a device such as a PDA. For example, there is a need for directly creating to-do lists, important information, and daily records on the touch screen, and saving them in the terminal.

Therefore, there is a need for a method and system for processing a document that can effectively create and edit a document on a touch screen.

### SUMMARY OF THE INVENTION

The present invention provides a method and a system that, in creating a document or a memo on a touch screen, may intuitively edit the document or memo, without using a menu structure.

The present invention also provides a method and a system that may effectively create a document on a touch screen by introducing a multilayer concept.

According to an aspect of the present invention, there is provided a method of processing a multilayer document using a touch screen, including receiving a first input of a user on the touch screen, creating a plurality of documents according to the first input, wherein the documents are divided by layers, receiving a second input of the user on the touch screen, and performing a document command on the plurality of documents according to the second input, by at least one of merging, segmenting, and deleting the layers.

According to another aspect of the present invention, there is provided a system for processing a multilayer document on a touch screen, including a first input unit which receives a first input of a user on the touch screen, a document creation unit to create a plurality of documents according to the first input, wherein the documents are divided by layers, a second input unit which receives a second input of the user on the touch screen, and a document command unit which performs a document command on the plurality of documents according to the second input by at least one of merging, segmenting, and deleting the layers.

### BRIEF DESCRIPTION OF THE DRAWINGS

The above and/or other aspects of the present invention will be more apparent by describing exemplary embodiments of the present invention with reference to the accompanying drawings, in which:

FIG. 1 is a diagram showing an example of a menu structure of a general memo pad;

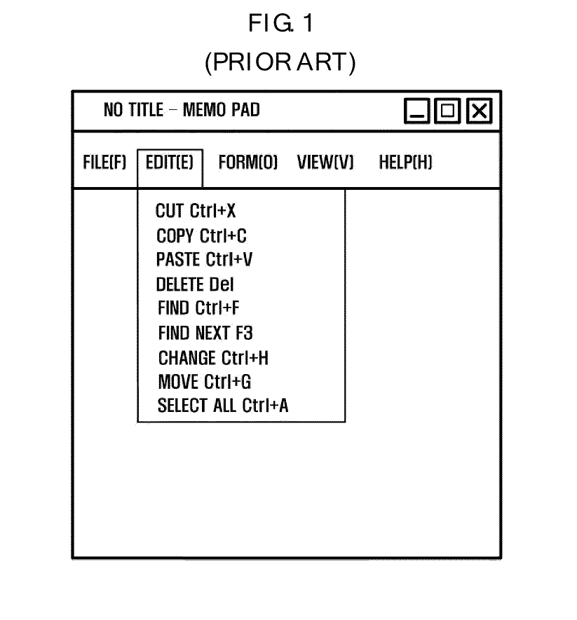

FIG. 2 is a flowchart illustrating a method of processing a multilayer document using a touch screen according to an exemplary embodiment of the invention;

FIG. 3 is a diagram illustrating a memo on a touch screen in a method of processing a multilayer document using a touch screen according to an exemplary embodiment of the invention;

FIG. 4 is a diagram illustrating an example of creating a document in a method of processing a multilayer document using a touch screen according to an exemplary embodiment of the invention;

FIG. 5 is a diagram illustrating an example of saving a document in a method of processing a multilayer document using a touch screen according to an exemplary embodiment of the invention;

FIG. 6 is a diagram illustrating an example of deleting a document in a method of processing a multilayer document using a touch screen according to an exemplary embodiment of the invention;

FIG. 7 is a diagram illustrating an example of merging documents in a method of processing a multilayer document using a touch screen according to an exemplary embodiment of the invention;

FIG. 8 is a diagram illustrating an example of segmenting a document in a method of processing a multilayer document using a touch screen according to an exemplary embodiment of the invention;

FIG. 9 is a diagram illustrating an example of inserting an object in a method of processing a multilayer document using a touch screen according to an exemplary embodiment of the invention; and

FIG. 10 is a block diagram showing a system for processing a multilayer document on a touch screen according to an exemplary embodiment of the invention.

### DESCRIPTION OF THE EXEMPLARY EMBODIMENTS

Hereinafter, exemplary embodiments will be described in detail with reference to the accompanying drawings. The aspects and features of the present invention and methods for achieving the aspects and features will be apparent by referring to the embodiments to be described in detail with reference to the accompanying drawings. However, the present invention is not limited to the embodiments disclosed hereinafter, but may be implemented in diverse forms. The matters defined in the description, such as the detailed construction and elements, are nothing but specific details provided to assist those of ordinary skill in the art in a comprehensive understanding of the invention, and the present invention is only defined within the scope of the appended claims.

The present invention will be described herein with reference to the accompanying drawings illustrating block diagrams and flowcharts for explaining a system and method of saving digital content classified by person-based clustering according to embodiments of the present invention. It will be understood that each block of the flowchart illustrations, and combinations of blocks in the flowchart illustrations, may be implemented by computer program instructions. The computer program instructions may be provided to a processor of a general purpose computer, special purpose computer, or other programmable data processing apparatus to produce a machine, such that the instructions, which execute via the processor of the computer or other programmable data processing apparatus, create means for implementing the functions specified in the flowchart block or blocks.

The computer program instructions may also be stored in a computer usable or computer-readable memory that may direct a computer or other programmable data processing apparatus to function in a particular manner, such that the instructions stored in the computer usable or computer-readable memory may produce an article of manufacture including instruction means that implement the function specified in the flowchart block or blocks.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Also, each block of the flowchart illustrations may represent a module, segment, or portion of code, which comprises one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

In the exemplary embodiments, the term “unit”, as used herein, may be implemented as a kind of module. Here, the term “module” means, but is not limited to, a software or hardware component, such as a Field Programmable Gate Array (FPGA) or Application Specific Integrated Circuit (ASIC), which performs certain tasks. A module may advantageously be configured to reside on the addressable storage medium and configured to execute on one or more processors. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules.

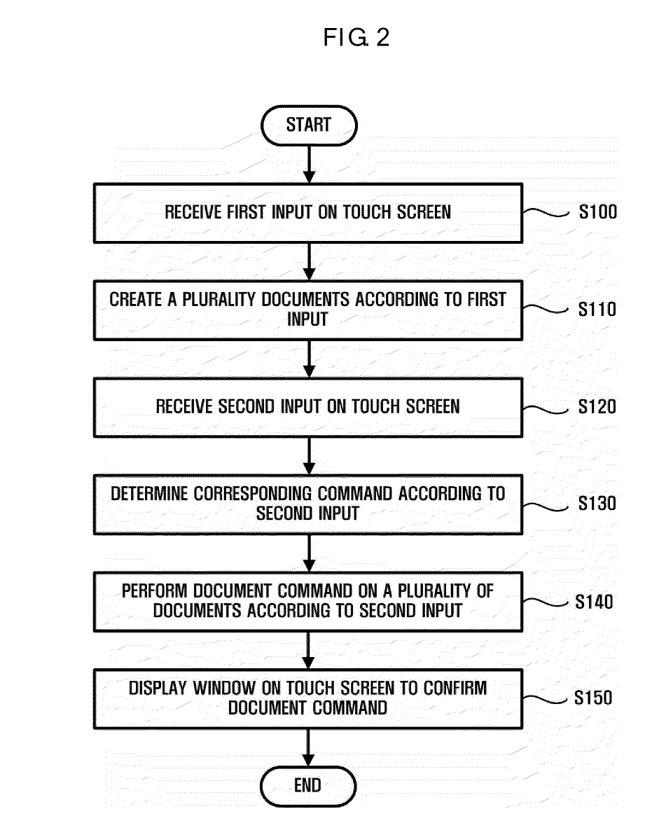

FIG. 2 is a flowchart illustrating a method of processing a multilayer document using a touch screen according to an exemplary embodiment of the invention. A first input is received on a touch screen (Step S100). Here, the first input refers to data to be input by a user to create a document on the touch screen. Generally, the touch screen may receive a user's input by detecting when a user's finger or a touch pen touches the touch screen. The touch screen is provided with a general sensor unit, such as a touch sensor, such that whether the user touches the touch screen is detected according to a signal from the sensor unit.

The touch sensor may be implemented in various ways, including a reduced pressure type and a capacitive type. In the reduced pressure type, wirings are densely provided to detect a pressure to be applied to the surface of the touch screen, to determine whether the user touches the touch screen. In the capacitive type, electric charges (current flow) are accumulated on the surface of the touch screen which contains sensors. In this case, whether the user touches the touch screen is detected according to a degree of electric charge loss when the user touches the touch screen.

A document is created according to the first input (Step S110). One or more documents may be created according to the first input. In an exemplary embodiment of the invention, a “layer” concept may be introduced to a plurality of documents. A plurality of documents on the touch screen may have different layers. Here, the “layer” is information for separating the documents on the touch screen, and is given to each document. The documents may be merged or deleted by merging or deleting the layers.

The document to be created is an empty document. Accordingly, the user may input various text to the document to be created. For example, in the present embodiment of the invention, it is assumed that a document to be used is a memo pad. The memo pad may save text such as a Post-it note as a document. In the memo pad, a number of characters to be input and a font may be fixedly defined in consideration of a size of the memo pad. Accordingly, the user may input, for example, a to-do list or a schedule in the created empty document.

To execute various processes on the plurality of documents, a second input is received from the user on the touch screen (Step S120). The user may merge, segment, delete, or save the documents on the touch screen. The processes may include document merging, segmentation, deletion, or saving.

The second input is a user signal that is input on the touch screen according to predetermined rules. The user may draw a trace on the touch screen with his/her finger or a touch pen according to a prescribed input system. The trace input on the touch screen becomes the second input.

A corresponding document command may be determined by receiving the trace on the touch screen and determining the user's intention (Step S130). At this time, since the pattern of the second input on the touch screen may vary according to users, the corresponding document command may be determined after noise is removed from the second input.

If the second input is received, the document commands are executed on the plurality of documents (Step S140). For example, if the second input is a command to merge documents, merging is executed on the documents.

As such, merging, segmentation, deletion, or saving may be executed as the document commands.

When a document command is executed, the confirmation of the document command execution may be displayed on the touch screen (Step S150). This is to confirm whether to execute the document command. For example, a pop-up window including “OK” and “Cancel” buttons is opened on the touch screen. Accordingly, the user may confirm to execute the document command by selecting “OK” button. The user may cancel execution of the document command by selecting the “Cancel” button.

As described above, document merging, segmentation, deletion, or saving may be executed by the input on the touch screen, without using the menu structure on the touch screen. In addition, since the layer concept is introduced in document merging, segmentation, deletion, or saving, the document commands may be efficiently executed by layer merging, segmentation, or deletion.

Hereinafter, various types of document commands according to an exemplary embodiment of the invention will be described.

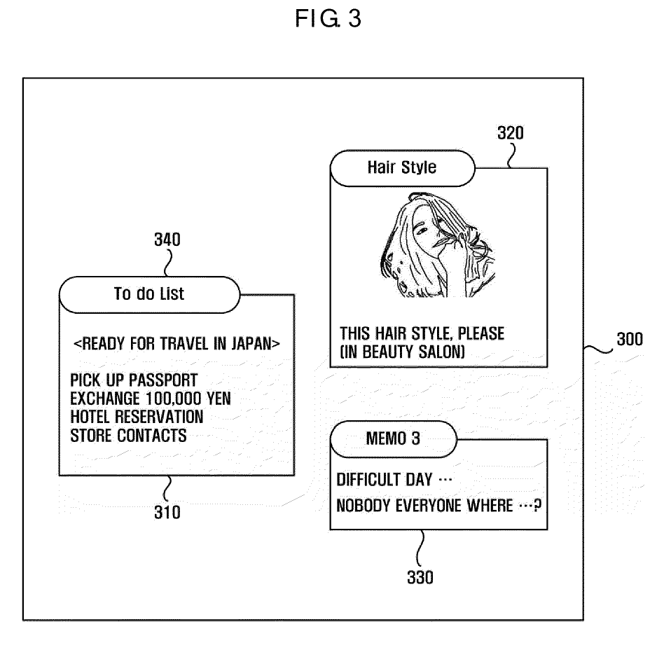

FIG. 3 is a diagram illustrating a memo on a touch screen 300 in a method of processing a multilayer document using a touch screen according to an exemplary embodiment of the invention. For example, three memo pads 310, 320, and 330 are created on a touch screen 300. At the top of each memo pad, a title 340 is positioned. In the exemplary embodiment, the memo pads 310, 320, and 330 are recognized on a layer basis, and, thus, a plurality of memo pads 310, 320, and 330 may be created on the single touch screen 300.

In the exemplary embodiment, the creation and merging of the memo pads may be executed within a short time by recognizing the traces on the touch screen 300, without searching the menu structure. Then, the document commands may be executed in various ways, as for example, by document merging and segmentation.

In addition, memos and sporadic information may be created and saved within a short time to be used as a mind map in a portable device or a business device.

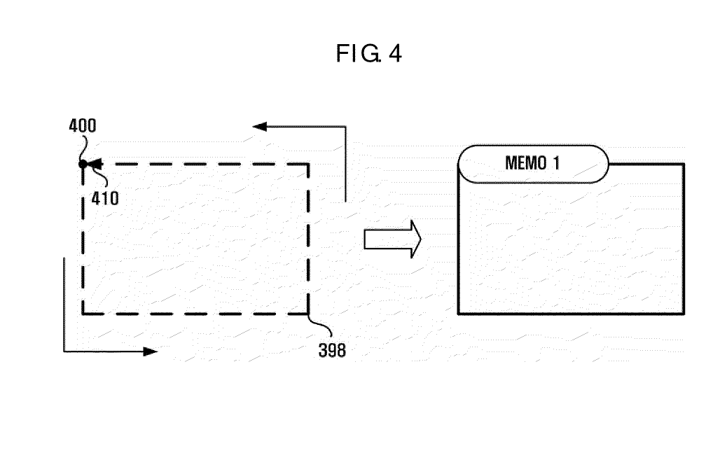

FIG. 4 is a diagram illustrating an example of creating a document in a method of processing a multilayer document using a touch screen according to an exemplary embodiment of the invention. Referring to FIG. 4, the user draws an outline corresponding to the size of a memo pad by his/her finger or a stylus pen. The touch screen receives the trace drawn by the user as the “first input”. For example, as the first input to create a document, the user draws a trace 398 corresponding to the size of a document from a start point 400 to an end point 410. On the touch screen, when the start point 400 and the end point 410 join each other, a rectangle is calculated on the basis of the trace 398 from the start point 400 to the end point 410 to create the document. Accordingly, if the first input is performed three times on the touch screen, three documents may be created, as shown in FIG. 3.

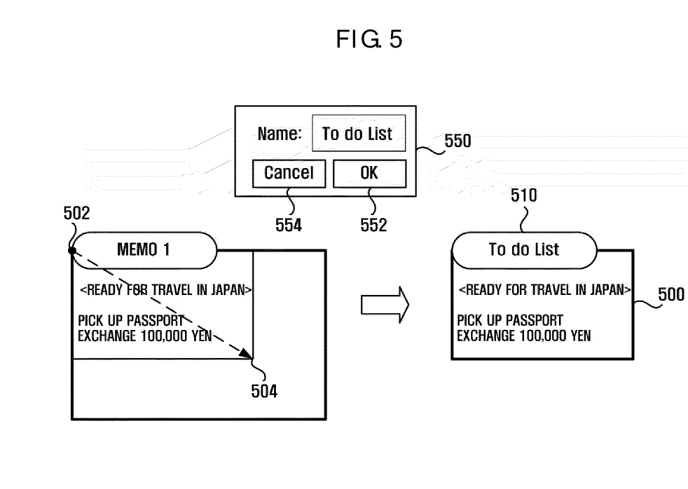

FIG. 5 is a diagram illustrating an example of saving a document in a method of processing a multilayer document using a touch screen according to an exemplary embodiment of the invention. Referring to FIG. 5, the touch screen receives the “second input” from the user to save the document. The second input is input data that instructs to execute a document command on the documents, and has different input patterns for predefined document commands.

For example, when a document command to save a document is executed, a command to save the document is input by a user's finger or a stylus pen. For example, a diagonal trace 501 of a part to be saved in the document is drawn by an input unit, for example, a user's finger or a stylus pen. The size of a document to be saved may be determined by a start point 502 and an end point 504 of the diagonal trace 501.

If the diagonal trace 501 is drawn on the touch screen by the input unit, a pop-up window 550 is opened to confirm saving the specified region. The name 510 of the document to be saved is input in the pop-up window 550. If an “OK” button 552 is selected, a document 500 having a corresponding size is saved. If a “Cancel” button 554 is selected, the document saving is cancelled.

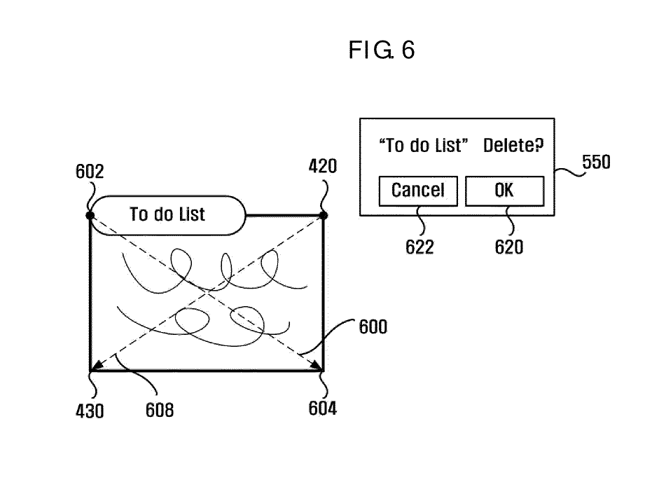

FIG. 6 is a diagram illustrating an example of deleting a document in a method of processing a multilayer document using a touch screen according to an exemplary embodiment of the invention. Referring to FIG. 6, an x-shaped trace is input for a document to be deleted on the touch screen. The x-shaped trace is formed by drawing two diagonals that cross at the apex of the document to be deleted.

If the two diagonals are input, a pop-up window 550 is opened. If an “OK” button 620 is selected, the document deletion is performed. If a “Cancel” button 622 is selected, the document deletion is cancelled.

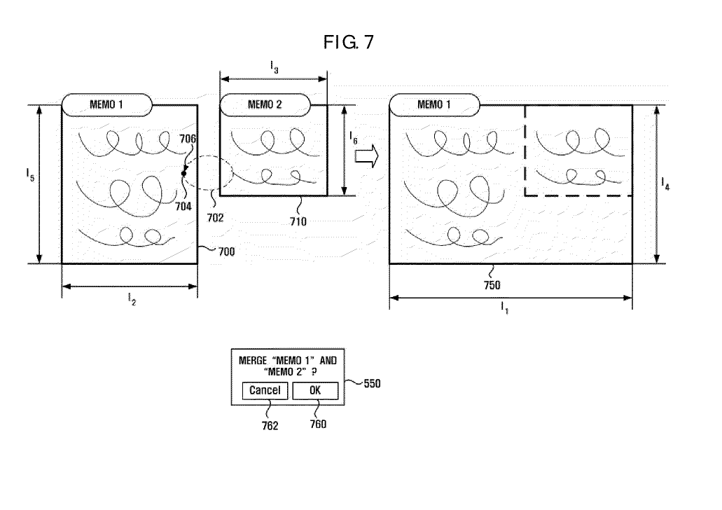

FIG. 7 is a diagram illustrating an example of merging documents in a method of processing a multilayer document using a touch screen according to an exemplary embodiment of the invention. Referring to FIG. 7, to merge the documents on the touch screen, a circular trace 702 with a start point 704 and an end point 706 is input to partially include the documents 700, 710 to be merged by the input unit into a merged document 750.

In the exemplary embodiment, a plurality of documents may be divided on a layer basis. Accordingly, document merging is to merge the documents that are divided on the layer basis, and, thus, has different characteristics from a general document merging. In the general document merging, two documents having different styles are connected in succession to create one document. In contrast, the document merging according to the exemplary embodiment may be performed by, for example, arranging pieces or putting together a puzzle. This document merging may merge the documents by recognizing the documents in the layer basis and merging the layers.

For example, for document merging of a first memo 700 and a second memo 710, the circular trace 702 that instructs to put together regions of the first memo 700 and the second memo 710 may be drawn to include parts of the first memo 700 and the second memo 710.

If the circular trace 702 is input on the touch screen, the first and second memos 700, 710 are merged. The merged memo 750 becomes a memo pad that has a horizontal length l₁, which is the sum of a horizontal length l₂ of the first memo 700 and a horizontal length l₃ of the second memo 710. A vertical length l₄ of the merged memo 750 is a longer vertical length of a vertical length l₅ of the first memo 700 and a vertical length l₆ of the second memo 710. In this example, the vertical length l₄ of the merged memo 750 is equal to the vertical length l₅ of the first memo 700. In the system for processing a multilayer document on a touch screen according to an embodiment, a first layer corresponding to the first memo 700 and a second layer corresponding to the second memo 710 may be merged into a single layer.

If a command to merge the documents, such as the memo pads, is received, the user confirms, through a pop-up window 550, whether to perform document merging. If the user selects an “OK” button 760 on the pop-up window 550, the document merging is performed. If the user selects a “Cancel” button 762, the document merging is cancelled.

The document merging may be performed on three or more documents. If a circular trace input through the input unit includes a plurality of documents, the plurality of documents may be merged.

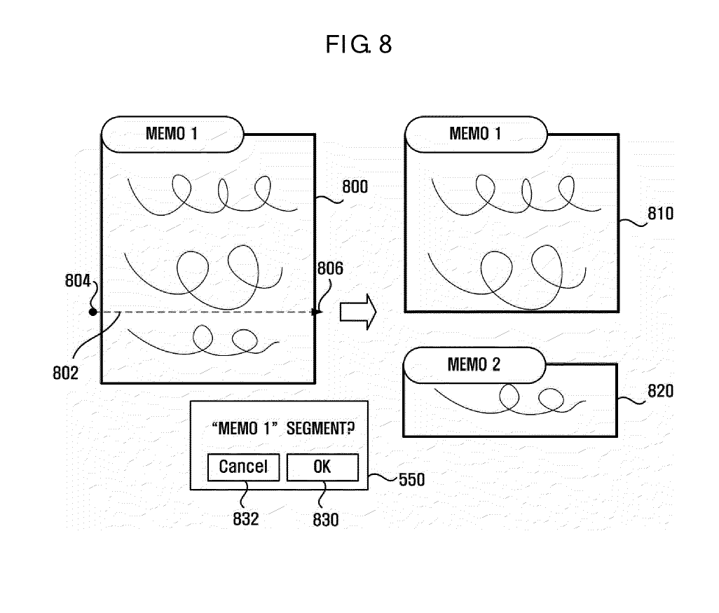

FIG. 8 is a diagram illustrating an example of segmenting a document in a method of processing a multilayer document using a touch screen according to an exemplary embodiment of the invention. Referring to FIG. 8, to segment a document, for example, a first memo 800 into two documents, a linear trace 802 is drawn on the touch screen to cross the document 800 by the input unit. If the linear trace 802 from a start point 804 to an end point 806 is drawn to cross a document, one document may be segmented into two documents 810 and 820.

For example, the first memo 800 is located in a first layer. If the first memo 800 in the first layer is segmented, the first layer may be segmented into two layers. While one layer is segmented into two layers, the document 800 may be segmented into two documents 810 and 820.

In segmenting a document into two documents, the user confirms, through a pop-up window 550, whether to perform document segmentation. If the user selects an “OK” button 830, the document segmentation is performed. If the user selects a “Cancel” button 832, the document segmentation is cancelled.

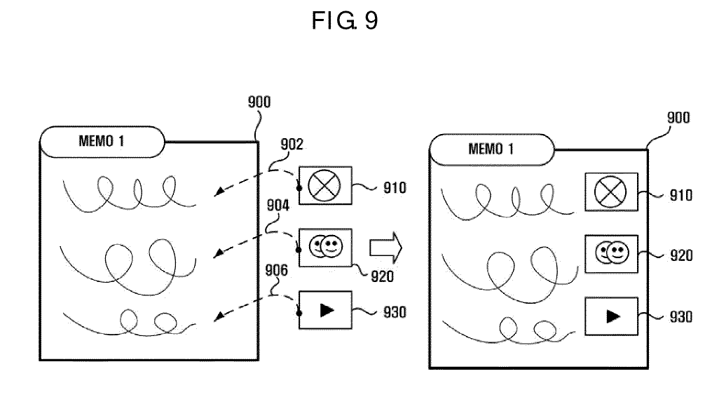

FIG. 9 is a diagram illustrating an example of inserting an object in a method of processing a multilayer document using a touch screen according to an exemplary embodiment of the invention. Referring to FIG. 9, to insert objects 910, 920, and 930 into a document region, the user may drag the objects with the input unit, for example, a user's finger or a stylus pen. For example, the object includes a visual object, such as a figure, an image, or a motion picture, excluding text, on the touch screen.

As shown in FIG. 9, if a corresponding curved trace 902, 904, and 906 is drawn to connect the objects 910, 920, and 930 to be inserted and a document by the input unit, the connected objects 910, 920, and 930 may be inserted into a document 900. Internally, the objects 910, 920, and 930 on the touch screen are recognized as the layers. Then, to insert an object into a document on the touch screen, a layer merging method is used. Therefore, since the layer merging method is used while the objects are inserted into the document, the position of an object on the document may be appropriately adjusted. In the case of general object insertion, when an object is inserted into a blank portion of the document or when the object overlaps the text of the document, it is difficult to adjust the position of the object. In contrast, according to an embodiment, since an object is inserted by the layer merging method, it is possible to efficiently adjust the position of the object to be inserted.

In the examples described above, the user performs an input on the touch screen by the input unit to create a document, and performs a document command on the created document. The document command means that the user performs a second input by the input unit to merge, segment, delete, or save documents, or insert an object into a document.

In the document commands, the layer concept is introduced in document merging and segmenting, or object insertion, which is different from the existing document merging and segmentation, thereby performing comparably intuitive and efficient document commands. In addition, a document creation or an object insertion may be performed without using a menu structure, and thus it may be efficiently used for a mobile device or a business mind map.

According to the exemplary embodiment, the trace by the input unit, which is defined as the second input, is an example, and other traces may be defined to perform the document commands, such as document merging, segmentation, deletion, or saving. In addition, the traces for the document commands or the document creation are defined according to predetermined rules, thereby grasping the user's intention. For example, if the user draws an obscure trace with the input unit, the noise is eliminated to interpret the trace as a specific document command. As another example, if the obscure trace falls within a range according to a specific rule, the trace may be determined as a specific document command.

For example, if it is determined that a range from a start point to an end point in creating a document is within a critical length, a trace by the input unit may be determined as a command to create a document. In the case of a document deletion, if it is determined that the input unit touches at four corners of the document and a trace crosses at the center of the document, the trace may be determined as a command to delete a document.

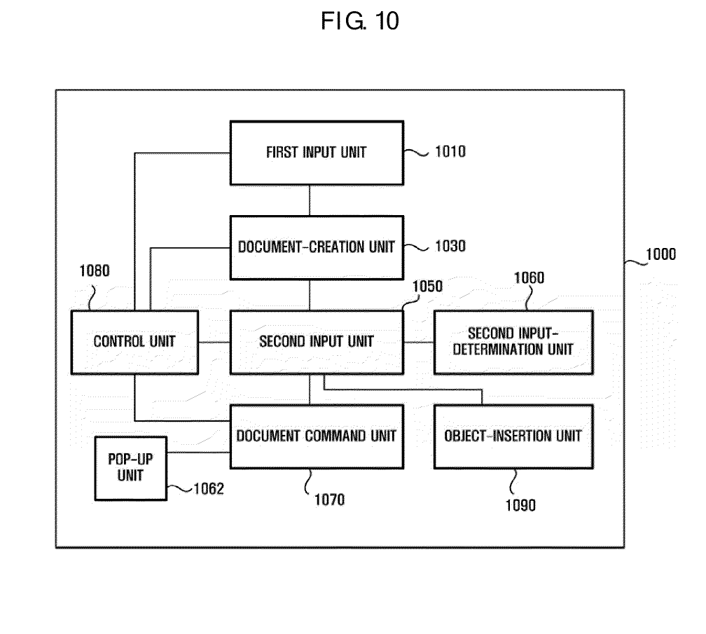

FIG. 10 is a block diagram showing a system for processing a multilayer document on a touch screen according to another exemplary embodiment of the invention. Referring to FIG. 10, a system 1000 for processing a multilayer document on a touch screen according to an embodiment includes a first input unit 1010, a document creation unit 1030, a second input unit 1050, a document command unit 1070, an object insertion unit 1090, a second input determination unit 1060, a pop-up unit 1062, and a control unit 1080.

The first input unit 1010 receives a first input from the input unit, such as a user's finger or a stylus pen, on the touch screen. The first input unit 1010 detects whether the input unit touches the touch screen and receives the user's input. For example, the first input unit 1010 receives a command to create a document from the input unit by the touch sensor (not shown).

The document creation unit 1030 creates a document according to the first input. The document creation unit 1030 may create a plurality of documents according to the first input. For example, if the first input is a rectangular trace pattern that is drawn on the touch screen by the input unit or a square trace pattern that the start point and the end point are the same, the document creation unit 1030 may create a document that corresponds to the size of the square. The created documents have different layers. Therefore, the document commands, such as document merging, deletion, and segmentation may be performed on a layer basis.

The second input unit 1050 receives a second input on the touch screen from the input unit, such as a user's finger or a stylus pen. The second input unit 1050 receives the second input that instructs to perform a document command on the created documents. The second input may be identical or similar to the trace that is predefined to perform a specific document command on the touch screen.

The second input determination unit 1060 determines a user's intention by assessing the second input from the second input unit 1050 according to predetermined rules. The second input determination unit 1060 may determine, according to the predetermined rules, whether a trace input by the input unit corresponds to a predefined document command. For example, in the case of the document deletion, when the input unit touches at four corners of a document and a trace crosses at the center of the document, the trace may be determined as a document deletion command. In the case of the document merging, when a trace includes parts of two or more documents, has a distance from a start point to an end point within a critical distance, and does not have a frame, the trace may be determined as a document merging command. In the case of the document segmentation, when a trace has a start point and an end point that pass both opposing sides of a document, respectively, the trace may be determined as a document segmentation command.

The document command unit 1070 performs a corresponding document command according to the second input by the input unit. The document command refers to a work to process a document, such as document merging, segmentation, deletion, or saving. Since the document command is performed by recognizing the documents as the layers, in the document command, the documents may be merged, segmented, or deleted as blocks or pieces. The document command may be performed according to a user's intuitive request, such that the document command may be simply performed.

The object insertion unit 1090 inserts an object, such as a figure, an image, or a motion picture, on the touch screen into a document according to the second input. The object insertion unit 1090 may insert the object into the document while recognizing the object as a layer.

The pop-up unit 1062 displays a window on the touch screen for the user to confirm the document command, while the document command is being performed on the documents.

The control unit 1080 controls the operations of the functional blocks 1010, 1020, 1030, 1050, 1060, 1062, 1070 and 1090.

As described above, document creation and document commands may be performed by recognizing a trace by an input unit, such as a user's finger or a pen, without using a menu on the touch screen. In addition, since the documents are recognized on a layer basis, document merging or segmentation may be performed according to the user's intention.

According to an exemplary embodiment, when creating a document or a memo on a touch screen, the document or the memo may be intuitively edited without using a menu structure.

In addition, a document creation on the touch screen may be effectively performed by introducing the multilayer concept. Although exemplary embodiments of the present invention have been described for illustrative purposes, those skilled in the art will appreciate that various modifications, additions and substitutions are possible, without departing from the scope and spirit of the invention as disclosed in the accompanying claims.

What is claimed is:

1. A method of processing a multilayer document using a touch screen, the method comprising:
receiving a first input via the touch screen;
creating a plurality of documents according to the first input, wherein the documents are divided by layers;
receiving a second input via the touch screen; and
performing a document command on the plurality of documents according to the second input by at least one of merging, segmenting, and deleting the layers.

2. The method of claim 1, wherein the document command comprises saving the plurality of documents.

3. The method of claim 1, wherein the documents comprise memo pads in which a number of characters and a font are fixed.

4. The method of claim 1, further comprising:
recognizing an object on the touch screen as a layer; and
inserting the recognized object into the documents according to the second input.

5. The method of claim 4, wherein the object comprises at least one of a figure, an image, and a motion picture.

6. The method of claim 1, wherein the first input comprises a trace by an input unit that indicates a size of a document to be created on the touch screen.

7. The method of claim 6, wherein the first input is made by drawing an outline corresponding to the size of the document to be created on the touch screen by the input unit, and a start point and an end point of the outline are connected with each other.

8. The method of claim 1, wherein the receiving the second input comprises determining a user's intention according to a predetermined rule.

9. The method of claim 1, wherein:
the second input indicates a document deletion and is an “x”-trace that is drawn by an input unit on the documents on the touch screen,
the second input indicates a document merging and is a circular trace that is drawn by an input unit to partially comprise the documents to be merged, or
the second input indicates a document segmentation and is a linear trace that is drawn by an input unit on the documents to be segmented.

10. The method of claim 1, further comprising:
displaying a window on the touch screen to confirm the document command while performing the document command on the documents.

11. A system for processing a multilayer document on a touch screen, the system comprising:
a first input unit which receives a first input via the touch screen;
a document creation unit to create a plurality of documents according to the first input, wherein the documents are divided by layers;
a second input unit which receives a second input via the touch screen; and
a document command unit which performs a document command on the plurality of documents according to the second input by at least one of merging, segmenting, and deleting the layers.

12. The system of claim 11, wherein the document command comprises saving of the plurality of documents.

13. The system of claim 11, wherein the documents comprise memo pads in which a number of characters and a font are fixed.

14. The system of claim 11, further comprising:
an object insertion unit which recognizes an object on the touch screen as a layer and inserts the recognized object into the documents according to the second input.

15. The system of claim 14, wherein the object comprises at least one of a figure, an image, and a motion picture.

16. The system of claim 11, wherein the first input comprises a trace by an input unit that indicates a size of a document to be created on the touch screen.

17. The system of claim 16, wherein the first input is made by drawing an outline corresponding to the size of the document to be created on the touch screen by the input unit, and a start point and an end point of the outline are connected with each other.

18. The system of claim 11, further comprising:
a second input determination unit which receives the second input and determines a user's intention according to a predetermined rule.

19. The system of claim 11, wherein:
the second input indicates a document deletion and is an “x”-trace that is drawn by an input unit on the documents on the touch screen,
the second input indicates a document merging and is a circular trace that is drawn by an input unit to partially comprise the documents to be merged, and
the second input indicates a document segmentation and is a linear trace that is drawn by an input unit on the documents to be segmented.

20. The system of claim 11, further comprising:
a pop-up unit which displays a window on the touch screen to confirm the document command, while the document command is being performed on the plurality of documents.
